(19) United States
(12) Patent Application Publication
(10) Pub. No.: US 2010/0250050 A1
(43) Pub. Date: Sep. 30, 2010

(54) CONTROL APPARATUS AND CONTROL METHOD FOR AUTOMATIC TRANSMISSION

(75) Inventor: Atsushi Ayabe, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, TOYOTA-SHI (JP)

(21) Appl. No.: 12/741,443

(22) PCT Filed: Dec. 10, 2008
(86) PCT No.: PCT/JP08/72906

§ 371 Date: May 5, 2010

(30) Foreign Application Priority Data
Dec. 13, 2007 (JP) 2007-321956

(51) Int. Cl. F16H 61/16; G06F 7/00

(52) U.S. Cl. 701/29

(57) ABSTRACT

When vehicle speed after determining that a downshift is to be performed is equal to or smaller than first permission vehicle speed VON or second permission vehicle speed VOFF, a controller of an ECT_ECU controls an automatic transmission so that the downshift is performed. When the vehicle speed after determining that the downshift is to be performed is larger than first permission vehicle speed VON or second permission vehicle speed VOFF, a first inhibitor inhibits the downshift.

### TECHNICAL FIELD

The present invention relates to a control apparatus and a control method for an automatic transmission, particularly to a technique for controlling the automatic transmission so that a downshift is performed in a case where vehicle speed is equal to or smaller than a threshold value and inhibiting the downshift in a case where the vehicle speed is larger than the threshold value.

### BACKGROUND ART

Conventionally, there is a known automatic transmission for automatically performing shifting. This automatic transmission determines a gear to be implemented based on a shift map taking for example vehicle speed and an accelerator pedal position as parameters. The shift map is set so that an optimal gear is implemented for an operation state of a vehicle in consideration to fuel consumption, drivability and the like.

However, there is a gap between time when the shifting is determined and time when the shifting is actually started. Therefore, a gear determined based on the shift map is not always optimal for all operation states. Then, there is a technique for predicting the operation state at the time of starting the shifting and determining whether or not the shifting is actually performed in accordance with the predicted operation state.

Japanese Patent Laying-Open No. 11-159609 discloses a downshift control apparatus for an automatic transmission provided with a one-way clutch of transmitting drive force from an engine to the side of a wheel and idling relative to reverse drive force and an oil hydraulic clutch in parallel to the one-way clutch in a driveline, for determining a shifting gear based on vehicle speed. This downshift control apparatus has an inhibition region determiner to determine a vehicle speed region where a coast downshift is inhibited based on the engine revolution number (engine speed) at the time of idling, a shifting starting time vehicle speed predictor to predict the vehicle speed at the time of starting the shifting in performing the shifting when the oil hydraulic clutch is engaged, and a shifting state determiner to determine whether or not the vehicle speed at the time of starting the shifting of the coast downshift is in the vehicle speed region where the coast downshift is inhibited. When the vehicle speed at the time of starting the shifting is in the vehicle speed region where the coast downshift is inhibited, control for inhibiting the coast downshift is performed. When the vehicle speed at the time of starting the shifting is larger than border vehicle speed, it is determined that the vehicle speed at the time of starting the shifting is in a shifting permission region and the downshift is executed. When the vehicle speed at the time of starting the shifting is equal to or smaller than the border vehicle speed, it is determined that the vehicle speed at the time of starting the shifting is in a shifting inhibition region and the downshift is inhibited.

According to the downshift control apparatus described in Japanese Patent Laying-Open No. 11-159609, when the vehicle speed at the time of starting the shifting is in the vehicle speed region where the coast downshift is inhibited, the coast downshift is inhibited until a shifting command to a next smaller gear. Thereby, a vehicle speed range where the drive force at the time of starting the shifting is radically changed from positive to negative is set to be an inhibition region so as to prevent shock at the time of starting the shifting.

However, in the downshift control apparatus described in Japanese Patent Laying-Open No. 11-159609, when the vehicle speed at the time of starting the shifting is larger than the border vehicle speed, the downshift is performed. Therefore, when the vehicle speed is extremely increased at the time of starting the downshift, the output shaft revolution number (speed) of a power source such as the engine may be excessive after the downshift is performed.

### DISCLOSURE OF THE INVENTION

An object of the present invention is to provide a control apparatus and a control method for an automatic transmission capable of preventing the output shaft revolution number of a power source from being excessive.

A control apparatus for an automatic transmission according to one aspect is a control apparatus for an automatic transmission installed in a vehicle. This control apparatus includes a sensor to detect vehicle speed and a control unit. The control unit determines whether or not a downshift is to be performed in accordance with the vehicle speed, determines whether or not the vehicle speed after determining that the downshift is to be performed is equal to or smaller than a predetermined threshold value, controls the automatic transmission so that the downshift is performed in a case where the vehicle speed after determining that the downshift is to be performed is equal to or smaller than the threshold value, and inhibits the downshift in a case where the vehicle speed after determining that the downshift is to be performed is larger than the threshold value.

According to this configuration, it is determined whether or not the downshift is to be performed in accordance with the vehicle speed. In the case where the vehicle speed after determining that the downshift is to be performed is equal to or smaller than the threshold value, the downshift is performed. In the case where the vehicle speed after determining that the downshift is to be performed is larger than the threshold value, the downshift is inhibited. Thereby, in a case where the vehicle speed is extremely increased after determining that the downshift is to be performed, it is possible to inhibit the downshift. Therefore, it is possible to prevent the output shaft revolution number of the power source coupled to the automatic transmission from being excessive.

Preferably, the control unit determines whether or not the vehicleaccelerates. The threshold value is set to be differentiated between a case where the vehicle accelerates and a case where the vehicle does not accelerate.

According to this configuration, the vehicle speed enabling the downshift so as to prevent the output shaft revolution number of the power source from being excessive is differentiated between the case where the vehicle accelerates and the case where the vehicle does not accelerate. Therefore, the threshold value used for determining whether the downshift is to be performed or inhibited is set to be differentiated between the case where the vehicle accelerates and the case where the vehicle does not accelerate. Thereby, it is possible to more surely prevent the output shaft revolution number of the power source from being excessive.

More preferably, the threshold value is set to be smaller in the case where the vehicle accelerates than in the case where the vehicle does not accelerate.

According to this configuration, the threshold value used for determining whether the downshift is to be performed or inhibited is set to be smaller in the case where the vehicle accelerates than in the case where the vehicle does not accelerate. Thereby, in the case where the vehicle accelerates, it is possible to perform the downshift only at smaller vehicle speed. Therefore, even when the vehicle speed is increased during the shifting, it is possible to prevent the output shaft revolution number of the power source from being excessive.

More preferably, the control unit determines whether or not the vehicle accelerates based on the vehicle speed and a throttle opening position.

According to this configuration, it is determined whether or not the vehicle accelerates based on the vehicle speed and the throttle opening position. Thereby, it is possible to precisely determine whether or not the vehicle accelerates.

More preferably, the control unit inhibits the downshift until the vehicle speed decreases to a speed equal to or smaller than a permission value set to be smaller than the threshold value in a case where the vehicle speed decreases from a speed larger than the threshold value to a speed equal to or smaller than the threshold value.

According to this configuration, in the case where the vehicle speed decreases from the speed larger than the threshold value to the speed equal to or smaller than the threshold value, the downshift is inhibited until the vehicle speed decreases to the speed equal to or smaller than the permission value set to be smaller than the threshold value. Thereby, during deceleration, the downshift can be inhibited with high vehicle speed and the downshift can be performed with low vehicle speed. Therefore, it is possible to regulate a radical increase in an engine brake. As a result, it is possible to smoothly reduce the vehicle speed.

More preferably, the control unit cancels inhibition of the downshift in a case where the vehicle accelerates and the vehicle speed is equal to or smaller than the threshold value.

According to this configuration, in the case where the vehicle accelerates and the vehicle speed is equal to or smaller than the threshold value, the inhibition of the downshift until the vehicle speed decreases to a speed equal to or smaller than the permission value is canceled. Thereby, in a case where there is a need for the downshift in order to accelerate the vehicle, it is possible to easily perform the downshift.

### BRIEF DESCRIPTION OF THE DRAWINGS

FIG. 1 is a schematic configuration diagram showing a vehicle.

FIG. 2 is a diagram showing a planetary gear unit.

FIG. 3 is a working table.

FIG. 4 is a diagram showing an oil hydraulic circuit.

FIG. 5 is a function block diagram of an ECT_ECU.

FIG. 6 is a shift map.

FIG. 7 is a map (1) used for determining whether or not the vehicle accelerates.

FIG. 8 is a map (2) used for determining whether or not the vehicle accelerates.

FIG. 9 is a diagram showing first permission vehicle speed VON and second permission vehicle speed VOFF.

FIG. 10 is a diagram showing third permission vehicle speed VOFFH.

FIG. 11 is a flowchart (1) showing a control structure of a program executed by the ECT_ECU.

FIG. 12 a flowchart (2) showing a control structure of a program executed by the ECT ECU.

FIG. 13 is a diagram (1) showing vehicle speed after determining that a downshift is to be performed.

FIG. 14 is a diagram (2) showing the vehicle speed after determining that the downshift is to be performed.

FIG. 15 is a diagram (3) showing the vehicle speed after determining that the downshift is to be performed.

FIG. 16 is a diagram (4) showing the vehicle speed after determining that the downshift is to be performed.

FIG. 17 is a diagram (5) showing the vehicle speed after determining that the downshift is to be performed.

FIG. 18 is a diagram (6) showing the vehicle speed after determining that the downshift is to be performed.

FIG. 19 is a diagram (7) showing the vehicle speed after determining that the downshift is to be performed.

### BEST MODES FOR CARRYING OUT THE INVENTION

Hereinafter, an embodiment of the present invention will be described with reference to the drawings. In the following description, the same parts are given the same reference numerals. Names and functions thereof are the same. Therefore, a detailed description thereof will not be repeated.

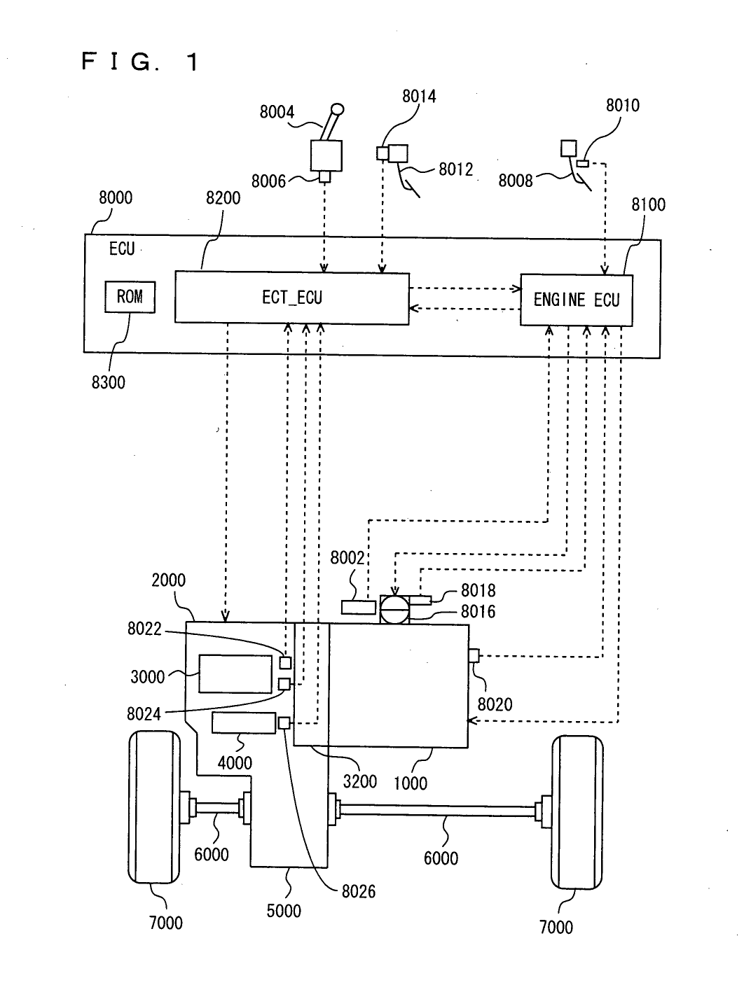

With reference to FIG. 1, a vehicle with a control apparatus according to the embodiment of the present invention installed will be described. This vehicle is a FF (Front engine Front drive) vehicle. It should be noted that the vehicle may be a vehicle other than the FF vehicle.

The vehicle includes an engine 1000, an automatic transmission 2000, a planetary gear unit 3000 forming a part of automatic transmission 2000, an oil hydraulic circuit 4000 forming a part of automatic transmission 2000, a differential gear 5000, a drive shaft 6000, front wheels 7000, and an ECU (Electronic Control Unit) 8000. The control apparatus according to the present embodiment is realized by for example executing a program stored in a ROM (Read Only Memory) 8300 of ECU 8000. It should be noted that the program to be executed by ECU 8000 may be stored in a recording medium such as a CD (Compact Disc) and a DVD (Digital Versatile Disc) and then distributed on the market.

Engine 1000 is an internal combustion engine for burning a mixture of a fuel injected from an injector (not shown) and the air inside a combustion chamber of a cylinder. A piston in the cylinder is pushed down by the combustion and a crankshaft is rotated. It should be noted that a motor may be used as a power source in addition to engine 1000.

Automatic transmission 2000 is coupled to engine 1000 via a torque converter 3200. Automatic transmission 2000 performs a shift of the revolution number of the crankshaft to a desired revolution number by forming a desired gear.

An output gear of automatic transmission 2000 is meshed with differential gear 5000. Drive shaft 6000 is coupled to differential gear 5000 by spline-fitting or the like. Motive power is transmitted to the left and right front wheels 7000 via drive shaft 6000.

An airflow meter 8002, a position switch 8006 of a shift lever 8004, an accelerator pedal position sensor 8010 of an accelerator pedal 8008, a pedal pressing force sensor 8014 of a brake pedal 8012, a throttle opening position sensor 8018 of an electronic throttle valve 8016, an engine speed sensor 8020, an input shaft speed sensor 8022, an output shaft speed sensor 8024, and an oil temperature sensor 8026 are connected to ECU 8000 via a harness and the like.

Airflow meter 8002 detects the air amount to be taken in engine 1000 and transmits a signal representing a detection result to ECU 8000. A position of shift lever 8004 is detected by position switch 8006, and a signal representing a detection result is transmitted to ECU 8000. A gear of automatic transmission 2000 is automatically implemented corresponding to the position of shift lever 8004. A driver may select a manual shift mode capable of selecting a gear arbitrarily in accordance with operations of the driver.

Accelerator pedal position sensor 8010 detects a position of accelerator pedal 8008 and transmits a signal representing a detection result to ECU 8000. Pedal pressing force sensor 8014 detects pedal pressing force of brake pedal 8012 (force generated by pressing brake pedal 8012 of the driver) and transmits a signal representing a detection result to ECU 8000.

Throttle opening position sensor 8018 detects an opening position of electronic throttle valve 8016 adjusted by an actuator and transmits a signal representing a detection result to ECU 8000. The air amount to be taken in engine 1000 (output of engine 1000) is adjusted by electronic throttle valve 8016.

It should be noted that the air amount to be taken in engine 1000 may be adjusted by changing the lift amount or an opening/closing phase of an intake valve (not shown) or an exhaust valve (not shown) instead of or in addition to electronic throttle valve 8016.

Engine speed sensor 8020 detects the revolution number (speed) of an output shaft (crankshaft) of engine 1000 and transmits a signal representing a detection result to ECU 8000. Input shaft speed sensor 8022 detects the input shaft revolution number NI of automatic transmission 2000 (a turbine revolution number NT of torque converter 3200) and transmits a signal representing a detection result to ECU 8000. Output shaft speed sensor 8024 detects an output shaft revolution number NO of automatic transmission 2000 and transmits a signal representing a detection result to ECU 8000. Vehicle speed is calculated (detected) from output shaft revolution number NO.

Oil temperature sensor 8026 detects a temperature (an oil temperature) of oil used for operating and lubricating automatic transmission 2000 (ATF: Automatic Transmission Fluid) and transmits a signal representing a detection result to ECU 8000.

ECU 8000 controls devices so that the vehicle is in a desired traveling state based on the signals transmitted from airflow meter 8002, position switch 8006, accelerator pedal position sensor 8010, pedal pressing force sensor 8014, throttle opening position sensor 8018, engine speed sensor 8020, input shaft speed sensor 8022, output shaft speed sensor 8024, oil temperature sensor 8026 and the like, a map and the program stored in ROM 8300.

In the present embodiment, ECU 8000 controls automatic transmission 2000 so that any of first to sixth gears is implemented in a case where a D (drive) range is selected as a shift range of automatic transmission 2000 by placing shift lever 8004 at a D (drive) position. Since any of the first to sixth gears is implemented, automatic transmission 2000 is capable of transmitting drive force to front wheels 7000. It should be noted that a gear of higher speed than the sixth gear, that is, a seventh gear or a eighth gear may be implemented in the D range. A gear to be implemented is determined based on a shift map preliminarily made by an experiment or the like taking the vehicle speed and the accelerator pedal position as parameters.

As shown in FIG. 1, ECU 8000 includes an engine ECU 8100 for controlling engine 1000, and an ECT (Electronic Controlled Transmission)_ECU 8200 for controlling automatic transmission 2000.

Engine ECU 8100 and ECT_ECU 8200 are formed so as to transmit and receive a signal to and from each other. In the present embodiment, a signal representing the accelerator pedal position and the like are transmitted from engine ECU 8100 to ECT_ECU 8200. A signal representing a torque demand amount determined as torque to be output by engine 1000 and the like is transmitted from ECT_ECU 8200 to engine ECU 8100.

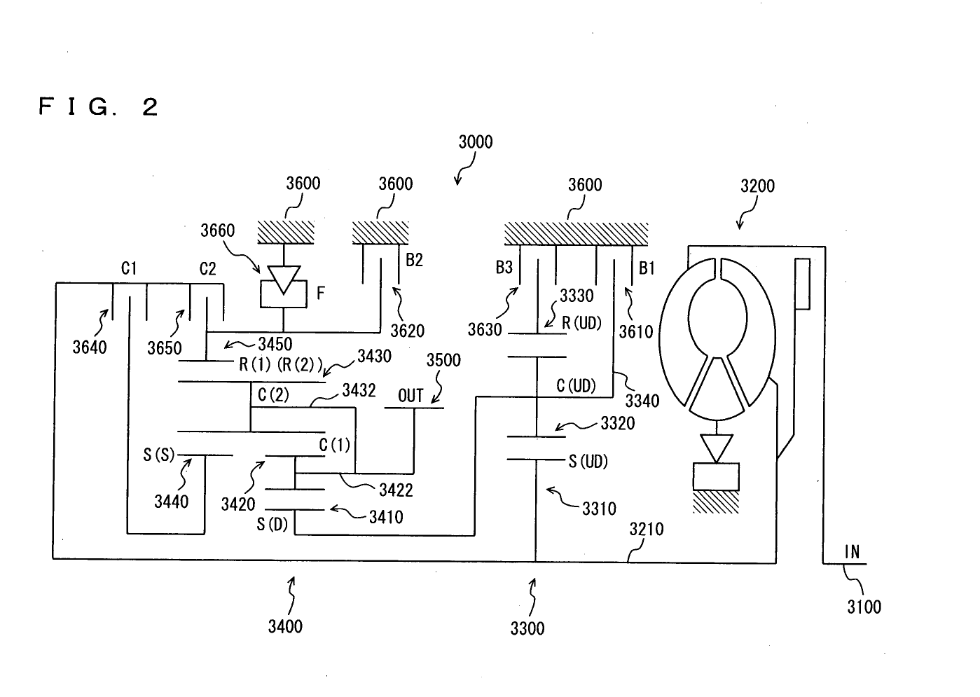

With reference to FIG. 2, planetary gear unit 3000 will be described. Planetary gear unit 3000 is connected to torque converter 3200 having an input shaft 3100 coupled to the crankshaft. Planetary gear unit 3000 includes a first set of planetary gear mechanism 3300, a second set of planetary gear mechanism 3400, an output gear 3500, B1, B2 and B3 brakes 3610, 3620 and 3630 fixed to a gear case 3600, C1 and C2 clutches 3640 and 3650, and a one-way clutch F 3660.

First set 3300 is a single pinion type planetary gear mechanism. First set 3300 includes a sun gear S (UD) 3310, a pinion gear 3320, a ring gear R (UD) 3330, and a carrier C (UD) 3340.

Sun gear S (UD) 3310 is coupled to an output shaft 3210 of torque converter 3200. Pinion gear 3320 is rotatably supported on carrier C (UD) 3340. Pinion gear 3320 is meshed with sun gear S (UD) 3310 and ring gear R (UD) 3330.

Ring gear R (UD) 3330 is fixed to gear case 3600 by B3 brake 3630. Carrier C (UD) 3340 is fixed to gear case 3600 by B1 brake 3610. Second set 3400 is a Ravigneaux type planetary gear mechanism. Second set 3400 includes a sun gear S (D) 3410, a short pinion gear 3420, a carrier C (1) 3422, a long pinion gear 3430, a carrier C (2) 3432, a sun gear S (S) 3440, and a ring gear R (1) (R (2)) 3450.

Sun gear S (D) 3410 is coupled to carrier C (UD) 3340. Short pinion gear 3420 is rotatably supported on carrier C (1) 3422. Short pinion gear 3420 is meshed with sun gear S (D) 3410 and long pinion gear 3430. Carrier C (1) 3422 is coupled to output gear 3500.

Long pinion gear 3430 is rotatably supported on carrier C (2) 3432. Long pinion gear 3430 is meshed with short pinion gear 3420, sun gear S (S) 3440 and ring gear R (1) (R (2)) 3450. Carrier C (2) 3432 is coupled to output gear 3500.

Sun gear S (S) 3440 is coupled to output shaft 3210 of torque converter 3200 by C1 clutch 3640. Ring gear R (1) (R (2)) 3450 is fixed to gear case 3600 by B2 brake 3620 and coupled to output shaft 3210 of torque converter 3200 by C2 clutch 3650. Ring gear R (1) (R (2)) 3450 is coupled to one-way clutch F 3660 and disabled in rotation during drive in the first gear.

One-way clutch F 3660 is provided in parallel with B2 brake 3620. That is, an outer race of one-way clutch F 3660 is fixed to gear case 3600, and an inner race is coupled to ring gear R (1) (R (2)) 3450 via a rotation shaft.

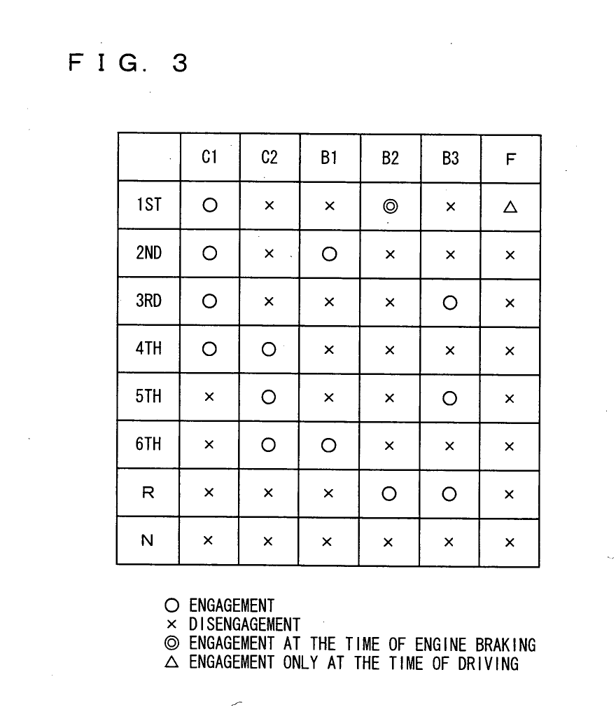

FIG. 3 shows a table illustrating a relationship between the shift gears and working states of the clutches and the brakes. First to sixth forward gears and a reverse gear are implemented by operating the brakes and the clutches with combinations shown in this table.

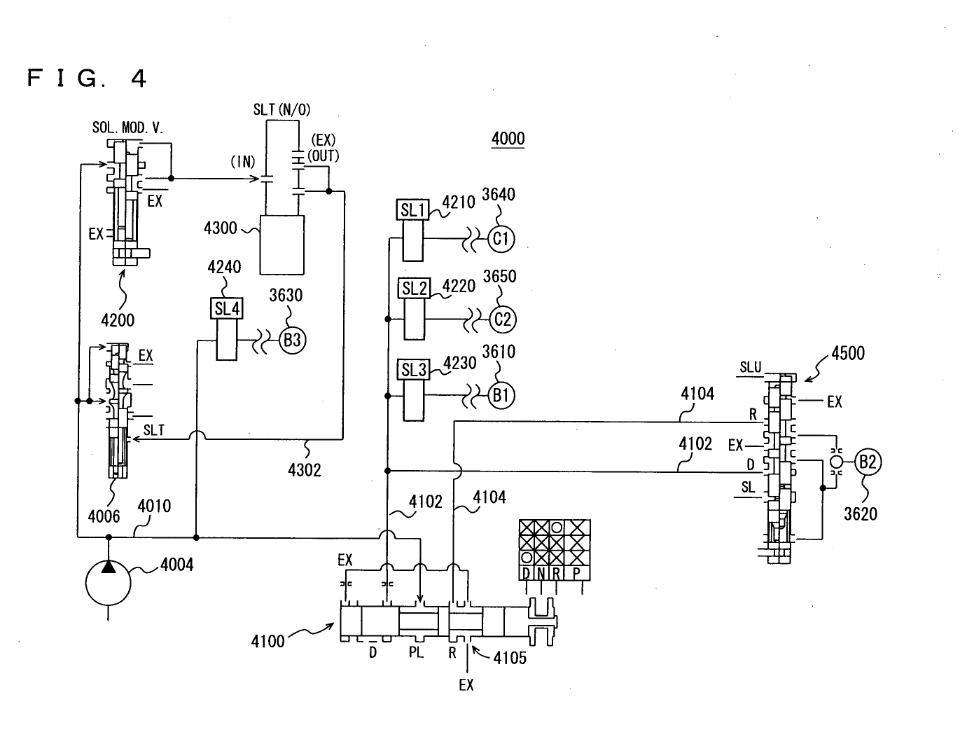

With reference to FIG. 4, a principal portion of oil hydraulic circuit 4000 will be described. It should be noted that oil hydraulic circuit 4000 is not limited to the one described below.

Oil hydraulic circuit 4000 includes an oil pump 4004, a primary regulator valve 4006, a manual valve 4100, a solenoid modulator valve 4200, an SL1 linear solenoid (hereinafter, indicated as SL (1)) 4210, an SL2 linear solenoid (hereinafter, indicated as SL (2)) 4220, an SL3 linear solenoid (hereinafter, indicated as SL (3)) 4230, an SL4 linear solenoid (hereinafter, indicated as SL (4)) 4240, an SLT linear solenoid (hereinafter, indicated as SLT) 4300, and a B2 control valve 4500.

Oil pump 4004 is coupled to the crankshaft of engine 1000. Oil pump 4004 is driven by rotation of the crankshaft so as to generate oil pressure. The oil pressure generated in oil pump 4004 is adjusted by primary regulator valve 4006 so as to generate line pressure.

Primary regulator valve 4006 is operated taking throttle pressure adjusted by SLT 4300 as pilot pressure. The line pressure is supplied to manual valve 4100 via a line pressure oil channel 4010.

Manual valve 4100 includes a drain port 4105. The oil pressure of a D range pressure oil channel 4102 and an R range pressure oil channel 4104 is discharged from drain port 4105. In a case where a spool of manual valve 4100 is at the D position, line pressure oil channel 4010 communicates with D range pressure oil channel 4102. Therefore, the oil pressure is supplied to D range pressure oil channel 4102. Here, R range pressure oil channel 4104 communicates with drain port 4105. Therefore, R range pressure of R range pressure oil channel 4104 is discharged from drain port 4105.

In a case where the spool of manual valve 4100 is at the R position, line pressure oil channel 4010 communicates with R range pressure oil channel 4104. Therefore, the oil pressure is supplied to R range pressure oil channel 401. Here, D range pressure oil channel 4102 communicates with drain port 4105. Therefore, D range pressure of D range pressure oil channel 4102 is discharged from drain port 4105.

In a case where the spool of manual valve 4100 is at the N position, both D range pressure oil channel 4102 and R range pressure oil channel 4104 communicate with drain port 4105. Therefore, the D range pressure of D range pressure oil channel 4102 and the R range pressure of R range pressure oil channel 4104 are discharged from drain port 4105.

The oil pressure supplied to D range pressure oil channel 4102 is eventually supplied to B1 brake 3610, B2 brake 3620, C1 clutch 3640 and C2 clutch 3650. The oil pressure supplied to R range pressure oil channel 4104 is eventually supplied to B2 brake 3620.

Solenoid modulator valve 4200 adjusts the line pressure at a constant level, and the oil pressure adjusted by solenoid modulator valve 4200 (solenoid modulator pressure) is supplied to SLT 4300.

SL (1) 4210 adjusts the oil pressure supplied to C1 clutch 3640. SL (2) 4220 adjusts the oil pressure supplied to C2 clutch 3650. SL (3) 4230 adjusts the oil pressure supplied to B1 brake 3610. SL (4) 4240 adjusts the oil pressure supplied to B3 brake 3630.

SLT 4300 adjusts the solenoid modulator pressure in accordance with a control signal from ECU 8000 based on the accelerator pedal position detected by accelerator pedal position sensor 8010 so as to generate the throttle pressure. The throttle pressure is supplied to primary regulator valve 4006 via SLT oil channel 4302. The throttle pressure is utilized as the pilot pressure of primary regulator valve 4006.

SL (1) 4210, SL (2) 4220, SL (3) 4230, SL (4) 4240, and SLT 4300 are controlled by the control signal sent from ECU 8000.

B2 control valve 4500 selectively supplies the oil pressure from one of D range pressure oil channel 4102 and R range pressure oil channel 4104 to B2 brake 3620. D range pressure oil channel 4102 and R range pressure oil channel 4104 are connected to B2 control valve 4500. B2 control valve 4500 is controlled by the oil pressure supplied from an SL solenoid valve (not shown) and an SLU solenoid valve (not shown) and the urge of a spring.

In a case where the SL solenoid valve is OFF and the SLU solenoid valve is ON, B2 control valve 4500 attains the left side state of FIG. 4. In this case, B2 brake 3620 is supplied with oil pressure having the D range pressure adjusted taking the oil pressure supplied from the SLU solenoid valve as the pilot pressure.

In a case where the SL solenoid valve is ON and the SLU solenoid valve is OFF, B2 control valve 4500 attains the right side state of FIG. 4. In this case, B2 brake 3620 is supplied with the R range pressure.

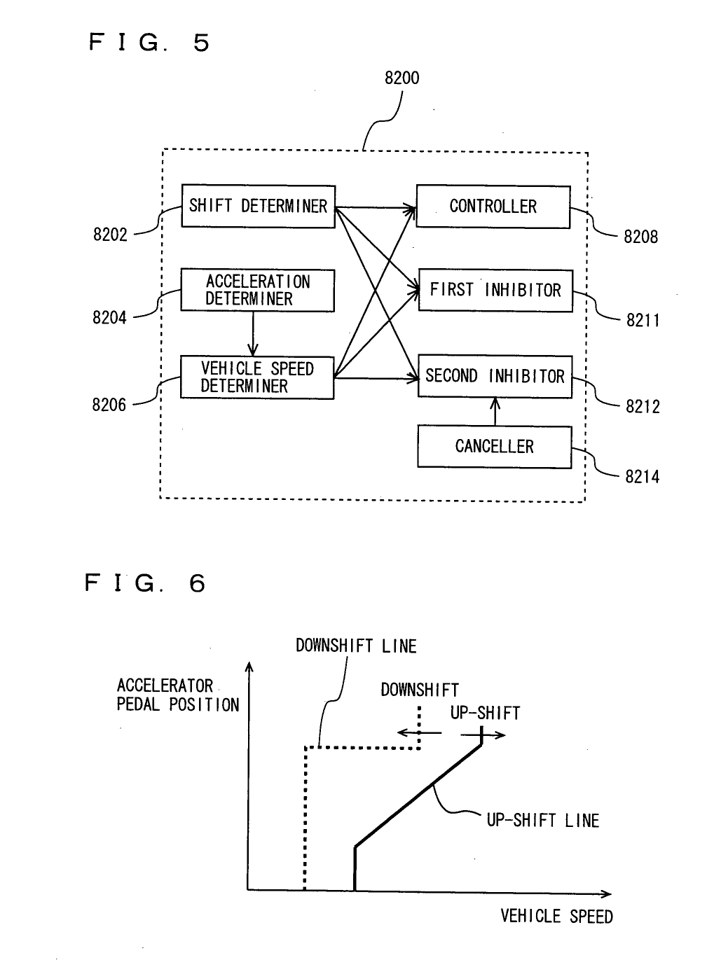

With reference to FIG. 5, functions of ECU 8200 will be described. It should be noted that the functions of ECU 8200 described below may be realized by either hardware or software.

ECT_ECU 8200 is provided with a shift determiner 8202, an acceleration determiner 8204, a vehicle speed determiner 8206, a controller 8208, a first inhibitor 8211, a second inhibitor 8212, and a canceller 8214.

As shown in FIG. 6, shift determiner 8202 determines a gear to be implemented in accordance with a shift map taking the vehicle speed and the accelerator pedal position as parameters. That is, it is determined whether or not the shifting is performed. In the shift map, an up-shift line and a downshift line are set for every type of the shifting (a combination of a gear before the shifting and a gear after the shifting).

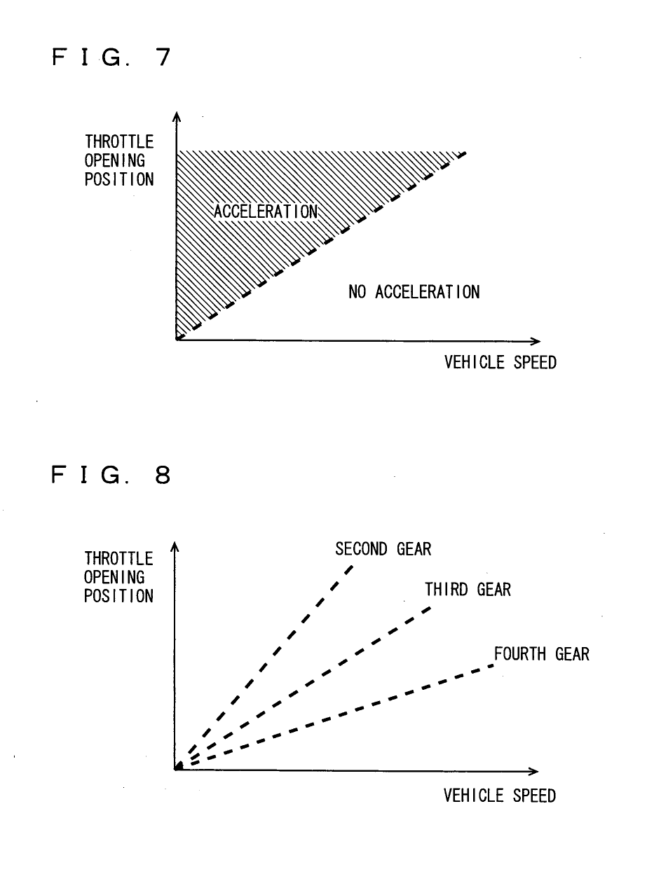

As shown in FIG. 7, acceleration determiner 8204 determines whether the vehicle accelerates or the vehicle does not accelerate (in other words, the vehicle speed is constant or decelerating) based on a map taking the vehicle speed and the throttle opening position as parameters. For example, in a case where the vehicle speed and the throttle opening position are in an upper region over a border line shown by a broken line in FIG. 7 (a region shown by diagonal lines in FIG. 7), it is determined that the vehicle accelerates. As shown in FIG. 8, the border line used for determining whether or not the vehicle accelerates is defined for every gear of automatic transmission 2000. It should be noted that a method for determining whether or not the vehicle accelerates is not limited to this.

Vehicle speed determiner 8206 determines whether or not the vehicle speed after determining that the downshift is to be performed is equal to or smaller than first permission vehicle speed VON in a case where the vehicle accelerates. More specifically, it is determined whether or not the vehicle speed after determining that the downshift is to be performed and before starting the shifting is equal to or smaller than first permission vehicle speed VON. That is, it is determined whether or not the vehicle speed at the time of actually starting the shifting is equal to or smaller than first permission vehicle speed VON.

Vehicle speed determiner 8206 also determines whether or not the vehicle speed after determining that the downshift is to be performed is equal to or smaller than second permission vehicle speed VOFF in a case where the vehicle does not accelerate. More specifically, it is determined whether or not the vehicle speed after determining that the downshift is to be performed and before starting the shifting is equal to or smaller than second permission vehicle speed VOFF. That is, it is determined whether or not the vehicle speed at the time of actually starting the shifting is equal to or smaller than second permission vehicle speed VOFF.

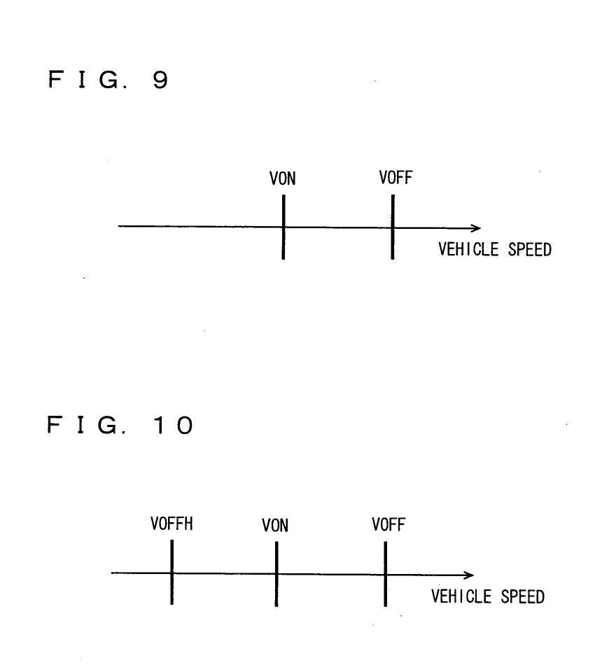

As shown in FIG. 9, first permission vehicle speed VON is set to be smaller than second permission vehicle speed VOFF. First permission vehicle speed VON and second permission vehicle speed VOFF are defined for every gear of automatic transmission 2000. It should be noted that first permission vehicle speed VON and second permission vehicle speed VOFF are not limited to these.

Controller 8208 controls automatic transmission 2000 so that the downshift is performed when the vehicle accelerates and the vehicle speed after determining that the downshift is to be performed is equal to or smaller than first permission vehicle speed VON. Controller 8208 also controls automatic transmission 2000 so that the downshift is performed when the vehicle does not accelerate and the vehicle speed after determining that the downshift is to be performed is equal to or smaller than second permission vehicle speed VOFF.

First inhibitor 8211 inhibits the downshift when the vehicle accelerates and the vehicle speed after determining that the downshift is to be performed is larger than first permission vehicle speed VON. First inhibitor 8211 also inhibits the downshift when the vehicle does not accelerate and the vehicle speed after determining that the downshift is to be performed is larger than second permission vehicle speed VOFF.

Second inhibitor 8212 inhibits the downshift until the vehicle speed decreases to a speed equal to or smaller than third permission vehicle speed VOFFH defined to be smaller than second permission vehicle speed VOFF as shown in FIG. 10 in a case where the vehicle speed decreases from a speed larger than second permission vehicle speed VOFF to a speed equal to or smaller than second permission vehicle speed VOFF. Third permission vehicle speed VOFFH is defined to be smaller than first permission vehicle speed VON. It should be noted that third permission vehicle speed VOFFH is not limited to this.

Canceller 8214 cancels inhibition of the downshift until the vehicle speed decreases to a speed equal to of smaller than third permission vehicle speed VOFFH in a case where the vehicle accelerates and the vehicle speed is equal to or smaller than first permission vehicle speed VON.

With reference to FIGS. 11 and 12, a control structure of a program executed by ECT_ECU 8200 will be described.

In Step (hereinafter, Step is abbreviated as S) 100, ECT_ECU 8200 determines whether or not a guard history OFF condition of a signal t_sftout is satisfied. In a case of satisfying either a condition that the vehicle accelerates and the vehicle speed after determining that the downshift is to be performed is equal to or smaller than first permission vehicle speed VON or a condition that the vehicle does not accelerate and the vehicle speed after determining that the downshift is to be performed is equal to or smaller than third permission vehicle speed VOFFH, it is determined that the guard history OFF condition is satisfied. When the guard history OFF condition is satisfied (YES in S100), the processing is moved to S102. If not (NO in S100), the processing is moved to S104.

In S102, ECT_ECU 8200 turns off a guard history of signal t_sftout.

In S104, ECT_ECU 8200 determines whether or not the gear determined based on the shift map is smaller than the gear output from ECT_ECU 8200 as a gear to be implemented (hereinafter, also described as shift output). That is, it is determined whether or not the downshift is performed. When the gear determined based on the shift map is smaller than the shift output (YES in S104), the processing is moved to S110. If not (NO in Step S104), the processing is moved to S106.

In S106, ECT_ECU 8200 turns off the guard history. Then, this processing is returned to S100.

In S110, ECT_ECU 8200 sets the same gear as the shift output as signal t_sftout and a signal t_sftout_e.

In S112, ECT_ECU 8200 determines whether or not the gear determined based on the shift map is smaller than the gear set as signal t_sftout. When the gear determined based on the shift map is smaller than the gear set as signal t_sftout (YES in S112), the processing is moved to S120. If not (NO in S112), the processing is moved to S114.

In S114, ECT_ECU 8200 implements the gear set as signal t_sftout_e. That is, the gear set as signal t_sftout_e is the shift output. Then, this processing is returned to S100.

In S120, ECT_ECU 8200 makes the gear set as signal t_sftout one gear lower.

In S122, ECT_ECU 8200 determines whether or not the guard history of signal t_sftout is turned off. When the guard history of signal t_sftout is turned off (YES in S122), the processing is moved to S130. If not (NO in S122), the processing is returned to S112.

In S130, ECT_ECU 8200 determines whether or not the vehicle accelerates. When the vehicle accelerates (YES in S130), the processing is moved to S132. When the vehicle does not accelerate (NO in S130), the processing is moved to S134.

In S132, ECT_ECU 8200 determines whether or not the vehicle speed after determining that the downshift is to be performed is equal to or smaller than first permission vehicle speed VON. When the vehicle speed after determining that the downshift is to be performed is equal to or smaller than first permission vehicle speed VON (YES in S132), the processing is moved to S136. If not (NO in S132), the processing is moved to S140.

In S134, ECT_ECU 8200 determines whether or not the vehicle speed after determining that the downshift is to be performed is equal to or smaller than second permission vehicle speed VOFF. When the vehicle speed after determining that the downshift is to be performed is equal to or smaller than second permission vehicle speed

VOFF (YES in S134), the processing is moved to S136. If not (NO in S134), the processing is moved to S150.

In S136, ECT_ECU 8200 sets the same gear as the gear set as signal t_sftout as signal t_sftout_e.

In S140, ECT_ECU 8200 determines whether or not the vehicle speed after determining that the downshift is to be performed is equal to or smaller than second permission vehicle speed VOFF. When the vehicle speed after determining that the downshift is to be performed is equal to or smaller than second permission vehicle speed VOFF (YES in S140), the processing is returned to S112. If not (NO in S140), the processing is moved to S142.

In S142, ECT_ECU 8200 turns on the guard history of signal t_sftout. In S150, ECT_ECU 8200 turns on the guard history of signal t_sftout.

An action of ECT_ECU 8200 in the present embodiment based on the above structure and the flowcharts will be described.

It is determined whether or not the guard history OFF condition of signal t_sftout is satisfied during traveling of the vehicle. When the guard history OFF condition is satisfied (YES in S100), the guard history is turned off (S102).

It is also determined whether or not the gear determined based on the shift map is smaller than the shift output (S104). When the gear determined based on the shift map is equal to or larger than the shift output (NO in S104), the guard history is turned off (S106).

Hereinafter, a case where it is determined that the downshift from a sixth gear to a fourth gear is to be performed from the shift map is taken as an example.

Downshift to Fourth Gear Performed

When the gear determined based on the shift map is smaller than the shift output (YES in S104), the same gear as the shift output is set as signal t_sftout and signal t_sftout_e (S110). Therefore, the sixth gear is set as signal t_sftout and signal t_sftout_e.

Then, it is determined whether or not the gear determined based on the shift map is smaller than the gear set as signal t_sftout (S112). At this time point, the gear determined based on the shift map is the fourth gear, and the gear set as signal t_sftout is the sixth gear (YES in S112). Therefore, the gear set as signal t_sftout is made one gear lower (S120). Consequently, a fifth gear is set as signal t_sftout. In the following processing, it is determined whether or not the downshift to the fifth gear can be performed.

In order to determine whether or not the downshift to the fifth gear can be performed, it is determined whether or not the guard history of signal t_sftout is turned off (S122). When the guard history is turned off (YES in S122), it is determined whether or not the vehicle accelerates (S130).

When the vehicle accelerates (YES in S130), it is determined whether or not the vehicle speed after determining the downshift is to be performed is equal to or smaller than first permission vehicle speed VON (S132). When the vehicle does not accelerate (NO in S130), it is determined whether or not the vehicle speed after determining the downshift is to be performed is equal to or smaller than second permission vehicle speed VOFF (S134).

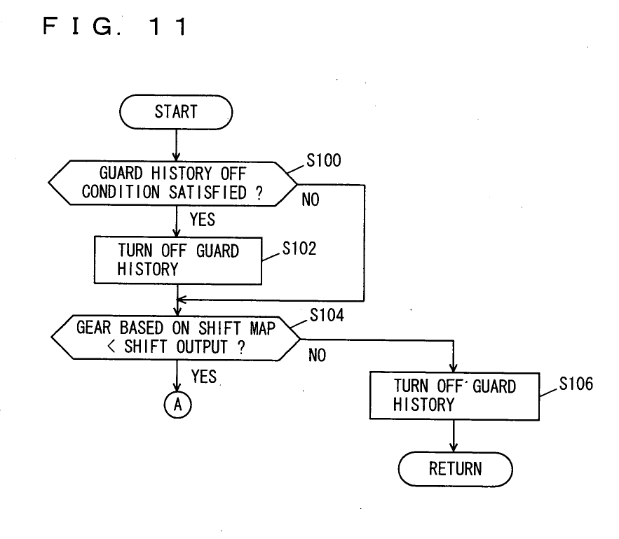

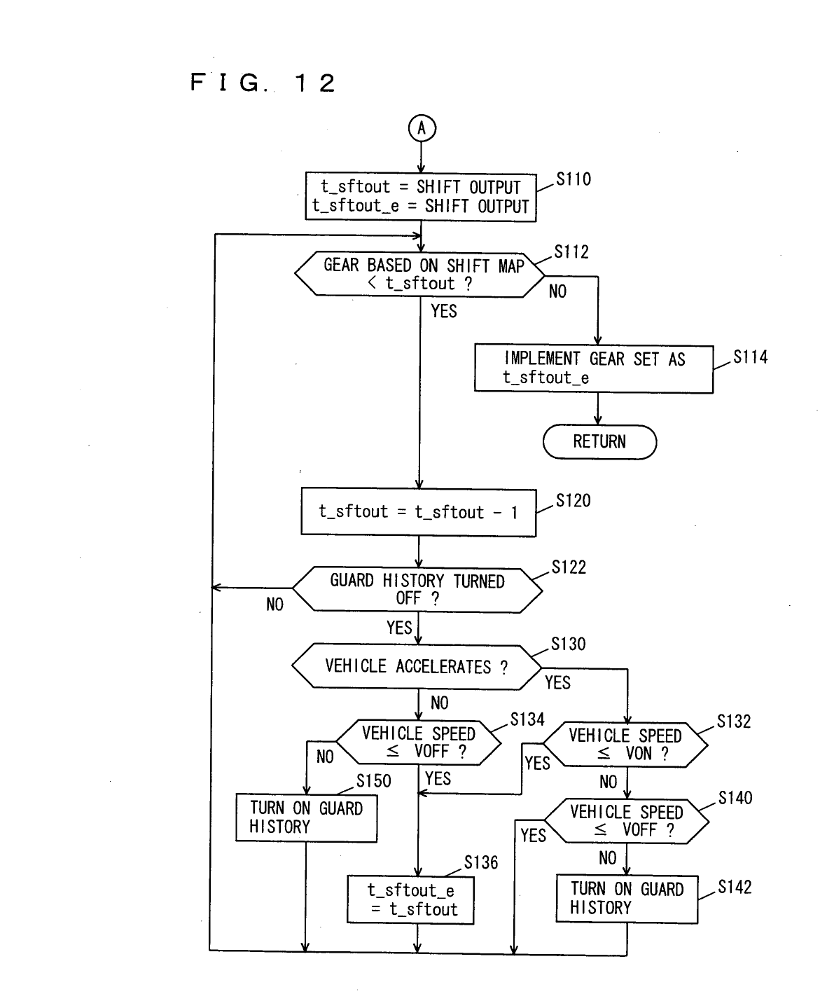

In a case where the vehicle speed is equal to or smaller than first permission vehicle speed VON (YES in S132) as shown in FIG. 13 or in a case where the vehicle speed is equal to or smaller than second permission vehicle speed VOFF (YES in S134) as shown in FIG. 14, an increase amount of the engine revolution number NE after the downshift is estimated to be small.

Therefore, the same gear as the gear set as signal t_sftout is set as signal t_sftout_e (S136). At this time point, the fifth gear is set as signal t_sftout_e.

Then, it is again determined whether or not the gear determined based on the shift map is smaller than the gear set as signal t_sftout (S112). At this time point, the gear determined based on the shift map is the fourth gear and the gear set as t_sftout is the fifth gear (YES in S112). Therefore, the gear set as signal t_sftout is made one gear lower (S120). Consequently, the fourth gear is set as signal t_sftout. In the following processing, it is determined whether or not the downshift to the fourth gear can be performed.

When the guard history is turned off (YES in S122), it is again determined whether or not the vehicle accelerates (S130). When the vehicle accelerates (YES in S130), it is determined whether or not the vehicle speed after determining that the downshift is to be performed is equal to or smaller than first permission vehicle speed VON (S132). When the vehicle does not accelerate (NO in S130), it is determined whether or not the vehicle speed after determining that the downshift is to be performed is equal to or smaller than second permission vehicle speed VOFF (S134).

In a case where the vehicle speed after determining that the downshift is to be performed is equal to or smaller than first permission vehicle speed VON (YES in S132) or equal to or smaller than second permission vehicle speed VOFF (YES in S134), the same gear as the gear set as signal t_sftout is set as signal t_sftout_e (S136). At this time point, the fourth gear is set as signal t_sftout_e.

Then, it is again determined whether or not the gear determined based on the shift map is smaller than the gear set as signal t_sftout (S112). At this time point, the gear determined based on the shift map is the fourth gear and the gear set as t_sftout is the fourth gear (NO in S112).

Therefore, the gear set as signal t_sftout_e is implemented (S114). At this time point, the fourth gear is set as signal t_sftout_e. Therefore, the downshift from the sixth gear to the fourth gear is performed.

Downshift to Fourth Gear Inhibited and Downshift to Fifth Gear Performed

When the gear determined based on the shift map is smaller than the shift output (YES in S104), the same gear as the shift output is set as signal t_sftout and signal t_sftout_e (S110). Therefore, the sixth gear is set as signal t_sftout and signal t_sftout_e.

Then, it is determined whether or not the gear determined based on the shift map is smaller than the gear set as signal t_sftout (S112). At this time point, the gear determined based on the shift map is the fourth gear and the gear set as signal t_sftout is the sixth gear (YES in S112). Therefore, the gear set as signal t_sftout is made one gear lower (S120). At this time point, the fifth gear is set as signal t_sftout.

Then, it is determined whether or not the guard history of signal t_sftout is turned off (S122). When the guard history is turned off (YES in S122), it is determined whether or not the vehicle accelerates (S130).

When the vehicle accelerates (YES in S130), it is determined whether or not the vehicle speed after determining that the downshift is to be performed is equal to or smaller than first permission vehicle speed VON (S132). When the vehicle does not accelerate (NO in S130), it is determined whether or not the vehicle speed after determining that the downshift is to be performed is equal to or smaller than second permission vehicle speed VOFF (S134).

In the case where the vehicle speed is equal to or smaller than first permission vehicle speed VON (YES in S132) or equal to or smaller than second permission vehicle speed VOFF (YES in S134), the same gear as the gear set as signal t_sftout is set as signal t_sftout_e (S136). At this time point, the fifth gear is set as signal t_sftout_e.

Then, it is again determined whether or not the gear determined based on the shift map is smaller than the gear set as signal t_sftout (S112). At this time point, the gear determined based on the shift map is the fourth gear and the gear set as t_sftout is the fifth gear (YES in S112). Therefore, the gear set as signal t_sftout is made one gear lower (S120). At this time point, the fourth gear is set as signal t_sftout.

When the guard history is turned off (YES in S122), it is again determined whether or not the vehicle accelerates (S130). When the vehicle accelerates (YES in S130), it is determined whether or not the vehicle speed after determining that the downshift is to be performed is equal to or smaller than first permission vehicle speed VON (S132). When the vehicle does not accelerate (NO in S130), it is determined whether or not the vehicle speed after determining that the downshift is to be performed is equal to or smaller than second permission vehicle speed VOFF (S134).

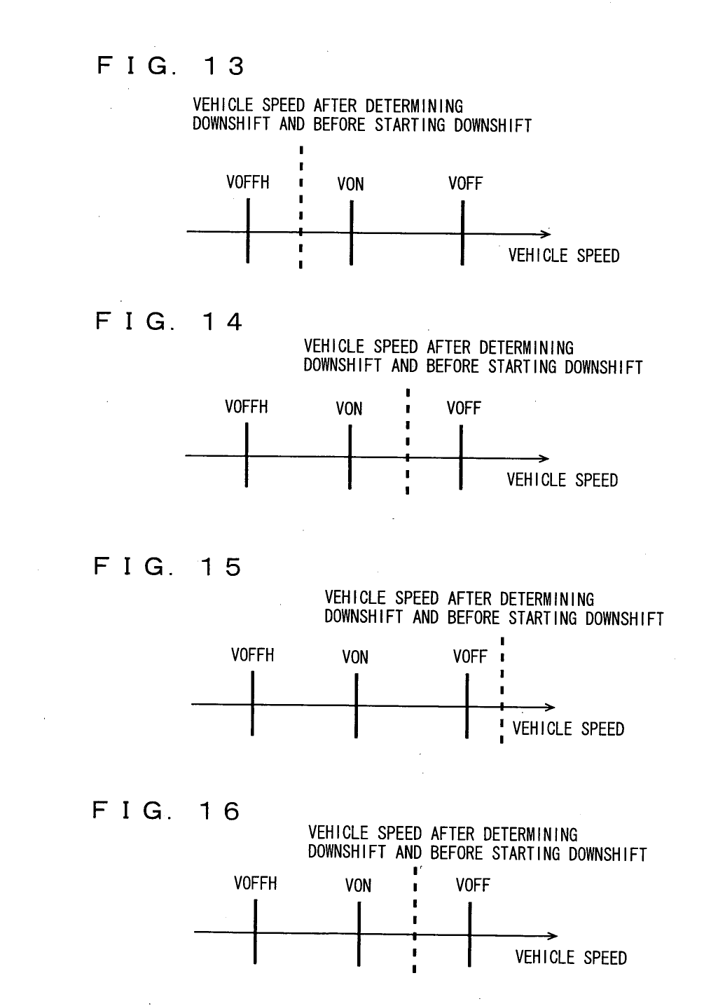

In a case where the vehicle speed is larger than second permission vehicle speed VOFF (NO in S134, NO in S140) as shown in FIG. 15, the guard history is turned on (S142, S150). Then, it is again determined whether or not the gear determined based on the shift map is smaller than the gear set as signal t_sftout (S112). In a case where the vehicle speed is larger than first permission vehicle speed VON (NO in S132) as shown in FIG. 16 and equal to or smaller than second permission vehicle speed VOFF (YES in S140), it is determined whether or not the gear determined based on the shift map is smaller than the gear set as signal t_sftout (S112) while maintaining the guard history to be off At this time point, the gear determined based on the shift map is the fourth gear and the gear set as signal t_sftout is the fourth gear (NO in S112).

Therefore, the gear set as signal t_sftout_e is implemented (S114). At this time point, the fifth gear is set as signal t_sftout_e. Therefore, the downshift from the sixth gear to the fifth gear is performed. That is, even when the gear determined based on the shift map is the fourth gear, the downshift to the fourth gear is inhibited.

Downshift to Fourth Gear and Fifth Gear Inhibited

When the gear determined based on the shift map is smaller than the shift output (YES in S104), the same gear as the shift output is set as signal t_sftout and signal t_sftout_e (S110). Therefore, the sixth gear is set as signal t_sftout and signal t_sftout_e.

Then, it is determined whether or not the gear determined based on the shift map is smaller than the gear set as signal t_sftout (S112). At this time point, the gear determined based on the shift map is the fourth gear and the gear set as signal t_sftout is the sixth gear (YES in S112). Therefore, the gear set as signal t_sftout is made one gear lower (S120). At this time point, the fifth gear is set as signal t_sftout.

Then, it is determined whether or not the guard history of signal t_sftout is turned off (S122). When the guard history is turned off (YES in S122), it is determined whether or not the vehicle accelerates (S130).

When the vehicle accelerates (YES in S130), it is determined whether or not the vehicle speed after determining the downshift is to be performed is equal to or smaller than first permission vehicle speed VON (S132). When the vehicle does not accelerate (NO in S130), it is determined whether or not the vehicle speed after determining the downshift is to be performed is equal to or smaller than second permission vehicle speed VOFF (S134).

In the case where the vehicle speed is larger than second permission vehicle speed VOFF (NO in S134, NO in S140), the guard history is turned on (S142, S150). In the case where the vehicle speed is larger than first permission vehicle speed VON (NO in S132) and equal to or smaller than second permission vehicle speed VOFF (YES in S140), the guard history is maintained to be off. The gear set as signal t_sftout_e is maintained to be the sixth gear.

Then, it is again determined whether or not the gear determined based on the shift map is smaller than the gear set as signal t_sftout (S112). At this time point, the gear determined based on the shift map is the fourth gear and the gear set as signal t_sftout is the fifth gear (YES in S112). Therefore, the gear set as signal t_sftout is made one gear lower (S120). At this time point, the fourth gear is set as signal t_sftout. When the guard history is turned off (YES in S122), it is again determined whether or not the vehicle accelerates (S130). When the vehicle accelerates (YES in S130), it is determined whether or not the vehicle speed after determining that the downshift is to be performed is equal to or smaller than first permission vehicle speed VON (S132). When the vehicle does not accelerate (NO in S130), it is determined whether or not the vehicle speed after determining that the downshift is to be performed is equal to or smaller than second permission vehicle speed VOFF (S134).

In the case where the vehicle speed is larger than second permission vehicle speed VOFF (NO in S134, NO in S140), the guard history is turned on (S142, S150).

In the case where the vehicle speed is larger than first permission vehicle speed VON (NO in S132) and equal to or smaller than second permission vehicle speed VOFF (YES in S140), the guard history is maintained to be off. The gear set as signal t_sftout_e is maintained to be the sixth gear.

Then, it is again determined whether or not the gear determined based on the shift map is smaller than the gear set as signal t_sftout (S112). When the guard history is turned on (NO in S122), it is again determined whether or not the gear determined based on the shift map is smaller than the gear set as signal t_sftout (S112). At this time point, the gear determined based on the shift map is the fourth gear and the gear set as signal t_sftout is the fourth gear (NO in S112).

Therefore, the gear set as signal t_sftout_e is implemented (S114). At this time point, the sixth gear is set as signal t_sftout_e. Therefore, the sixth gear is maintained. That is, even when the gear determined based on the shift map is the fourth gear, the downshift to the fourth gear and the fifth gear is inhibited.

Vehicle Speed Lowered from Value Larger Than Second Permission Vehicle Speed VOFF

As mentioned above, in the case where the vehicle speed is larger than second permission vehicle speed VOFF (NO in S134, NO in S140), the guard history is turned on (S142, S150). Then, when the gear determined based on the shift map is equal to or larger than the gear set as signal t_sftout (NO in S112), the gear set as signal t_sftout_e is implemented (S114). Here, it is supposed that the sixth gear is set as signal t_sftout_e and the sixth gear is maintained.

Then, when the vehicle speed is equal to or smaller than third permission vehicle speed VOFFH as shown in FIG. 17, the guard history OFF condition is satisfied (YES in S100). Therefore, the guard history is turned off (S102).

Then, when the gear determined based on the shift map is smaller than the shift output (YES in S104), the same gear as the shift output is again set as signal t_sftout and signal t_sftout_e (S110). Therefore, the sixth gear is again set as signal t_sftout and signal t_sftout_e.

Further, the processing of S112, S120 to S134 is executed. At this time point, the vehicle speed is equal to or smaller than second permission vehicle speed VOFF (YES in S134). Therefore, the gear lower than the sixth gear is set as signal t_sftout_e (S136). Consequently, as mentioned above, the downshift to the fourth gear or the fifth gear is finally performed.

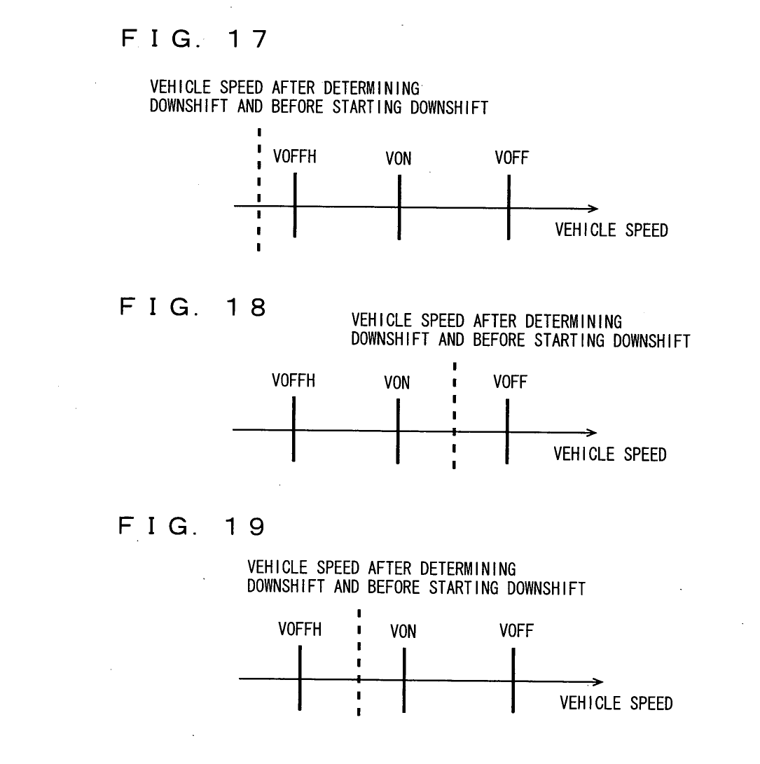

When the vehicle speed decreases to a speed equal to or smaller than second permission vehicle speed VOFF and the vehicle speed is larger than third permission vehicle speed VOFFH as shown in FIG. 18, the guard history OFF condition is not satisfied (NO in S100). Therefore, the guard history is maintained to be on.

Consequently, the processing of S112, S120 and S122 is repeated until the gear determined based on the shift map is equal to or larger than the gear set as signal t_sftout. In this case, the gear set as signal t_sftout_e is maintained to be the gear set in S110. As a result, the gear set in S110 is finally implemented(S114). That is, the sixth gear is maintained.

Thereby, in a case where the vehicle speed decreases from a speed larger than second permission vehicle speed VOFF to a speed equal to or smaller than second permission vehicle speed VOFF, the downshift is inhibited until the vehicle speed decreases to a speed equal to or smaller than third permission vehicle speed VOFFH set to be smaller than second permission vehicle speed VOFF.

Meanwhile, when the vehicle accelerates and the vehicle speed is equal to or smaller than first permission vehicle speed VON as shown in FIG. 19, the guard history OFF condition is satisfied (YES in S100). Therefore, the guard history is turned off (S102).

Then, when the gear determined based on the shift map is smaller than the shift output (YES in S104), the same gear as the shift output is again set as signal t_sftout and signal t_sftout_e (5110). Therefore, the sixth gear is again set as signal t_sftout and signal t_sftout_e.

Further, the processing of S112, S120 to S132 is executed. At this time point, the vehicle speed is equal to or smaller than first permission vehicle speed VON (YES in S132). Therefore, the gear lower than the sixth gear is set as signal t_sftout_e (S136). Consequently, as mentioned above, the downshift to the fourth gear or the fifth gear is finally performed. That is, the inhibition of the downshift until the vehicle speed decreases to a speed equal to or smaller than third permission vehicle speed VOFFH is canceled.

As mentioned above, in accordance with the control apparatus according to the present embodiment, in a case where the vehicle speed after determining that the downshift is to be performed is equal to or smaller than the permission vehicle speed, the downshift is performed. In a case where the vehicle speed after determining that the downshift is to be performed is larger than the permission vehicle speed, the downshift is inhibited. Thereby, in a case where the vehicle speed is extremely increased after determining that the downshift is to be performed, it is possible to inhibit the downshift. Therefore, it is possible to prevent the output shaft revolution number of the engine coupled to the automatic transmission from being excessive.

Although the present invention has been described and illustrated in detail, it is clearly understood that the same is by way of illustration and example only and is not to be taken by way of limitation, the scope of the present invention being interpreted by the terms of the appended claims.

1. A control apparatus for an automatic transmission installed in a vehicle, comprising:
a sensor to detect vehicle speed; and
a control unit, wherein
said control unit:
determines whether or not a downshift is to be performed in accordance with the vehicle speed;
determines whether or not the vehicle speed after determining that the downshift is to be performed is equal to or smaller than a predetermined threshold value;
controls said automatic transmission so that the downshift is performed in a case where the vehicle speed after determining that the downshift is to be performed is equal to or smaller than said threshold value; and
inhibits the downshift in a case where the vehicle speed after determining that the downshift is to be performed is larger than said threshold value.

2. The control apparatus for the automatic transmission according to claim 1, wherein
said control unit determines whether or not said vehicle accelerates, and
said threshold value is set to be differentiated between a case where said vehicle accelerates and a case where said vehicle does not accelerate.

3. The control apparatus for the automatic transmission according to claim 2, wherein
said threshold value is set to be smaller in the case where said vehicle accelerates than in the case where said vehicle does not accelerate.

4. The control apparatus for the automatic transmission according to claim 2, wherein
said control unit determines whether or not said vehicle accelerates based on the vehicle speed and a throttle opening position.

5. The control apparatus for the automatic transmission according to claim 1, wherein
said control unit inhibits the downshift until the vehicle speed decreases to a speed equal to or smaller than a permission value set to be smaller than said threshold value in a case where the vehicle speed decreases from a speed larger than said threshold value to a speed equal to or smaller than said threshold value.

6. The control apparatus for the automatic transmission according to claim 5, wherein
said control unit cancels inhibition of the downshift in a case where said vehicle accelerates and the vehicle speed is equal to or smaller than said threshold value.

7. A control method for an automatic transmission installed in a vehicle, comprising the steps of:
determining whether or not a downshift is to be performed in accordance with vehicle speed;
determining whether or not the vehicle speed after determining that the downshift is to be performed is equal to or smaller than a predetermined threshold value;
controlling said automatic transmission so that the downshift is performed in a case where the vehicle speed after determining that the downshift is to be performed is equal to or smaller than said threshold value; and
inhibiting the downshift in a case where the vehicle speed after determining that the downshift is to be performed is larger than said threshold value.

8. The control method for the automatic transmission according to claim 7, further comprising the step of:
determining whether or not said vehicle accelerates, wherein
said threshold value is set to be differentiated between a case where said vehicle accelerates and a case where said vehicle does not accelerate.

9. The control method for the automatic transmission according to claim 8, wherein
said threshold value is set to be smaller in the case where said vehicle accelerates than in the case where said vehicle does not accelerate.

10. The control method for the automatic transmission according to claim 8, wherein
said step of determining whether or not said vehicle accelerates includes the step of determining whether or not said vehicle accelerates based on the vehicle speed and a throttle opening position.

11. The control method for the automatic transmission according to claim 7, further comprising the step of:
inhibiting the downshift until the vehicle speed decreases to a speed equal to or smaller than a permission value set to be smaller than said threshold value in a case where the vehicle speed decreases from a speed larger than said threshold value to a speed equal to or smaller than said threshold value.

12. The control method for the automatic transmission according to claim 11, further comprising the step of:
canceling inhibition of the downshift in a case where said vehicle accelerates and the vehicle speed is equal to or smaller than said threshold value.

13. A control apparatus for an automatic transmission installed in a vehicle, comprising:
means for determining whether or not a downshift is to be performed in accordance with vehicle speed;
means for determining whether or not the vehicle speed after determining that the downshift is to be performed is equal to or smaller than a predetermined threshold value;
means for controlling said automatic transmission so that the downshift is performed in a case where the vehicle speed after determining that the downshift is to be performed is equal to or smaller than said threshold value; and
means for inhibiting the downshift in a case where the vehicle speed after determining that the downshift is to be performed is larger than said threshold value.

14. The control apparatus for the automatic transmission according to claim 13, further comprising:
determination means for determining whether or not said vehicle accelerates, wherein
said threshold value is set to be differentiated between a case where said vehicle accelerates and a case where said vehicle does not accelerate.

15. The control apparatus for the automatic transmission according to claim 14, wherein
said threshold value is set to be smaller in the case where said vehicle accelerates than in the case where said vehicle does not accelerate.

16. The control apparatus for the automatic transmission according to claim 14, wherein
said determination means includes means for determining whether or not said vehicle accelerates based on the vehicle speed and a throttle opening position.

17. The control apparatus for the automatic transmission according to claim 13, further comprising:
means for inhibiting the downshift until the vehicle speed decreases to a speed equal to or smaller than a permission value set to be smaller than said threshold value in a case where the vehicle speed decreases from a speed larger than said threshold value to a speed equal to or smaller than said threshold value.

18. The control apparatus for the automatic transmission according to claim 17, further comprising:
means for canceling inhibition of the downshift in a case where said vehicle accelerates and the vehicle speed is equal to or smaller than said threshold value.
